(19) United States
(12) Patent Application Publication
(10) Pub. No.: US 2017/0337156 A1
(43) Pub. Date: Nov. 23, 2017

(54) COMPUTING MACHINE ARCHITECTURE FOR MATRIX AND ARRAY PROCESSING

(71) Applicant: SITARAM YADAVALLI, SAN JOSE, CA (US)

(72) Inventor: SITARAM YADAVALLI, SAN JOSE, CA (US)

(73) Assignee: ONNIVATION LLC, SAN JOSE, CA (US)

(21) Appl. No.: 15/488,494

(22) Filed: Apr. 16, 2017

Related U.S. Application Data
(60) Provisional application No. 62/327,949, filed on Apr. 26, 2016.

(51) Int. Cl. G06F 15/80; H04L 12/933; G06F 15/173; G06F 9/52

(52) U.S. Cl. CPC G06F 15/8053; G06F 15/8023; G06F 15/17325; H04L 49/101; G06F 9/52; G06F 15/17337; H04L 49/15

(57) ABSTRACT

This invention discloses a novel paradigm, method and apparatus for Matrix Computing which include a novel machine architecture with an embedded storage space for holding matrices and arrays for computing which can be accessed by its columns or by its rows or both concurrently. A large capacity multi length instruction set with instructions and methods to load, store and compute with these matrices and arrays are also disclosed; a method and apparatus to secure, share, lock and unlock this embedded space for matrices under the control of an Operating System or a Virtual Machine Monitor by a plurality of threads and processes are also disclosed. A novel method and apparatus to handle immediate operands used by Immediate Instructions are also disclosed. The structure of the instructions with some key fields and a method for determining instruction length easily are also disclosed.

### BRIEF SUMMARY OF THE INVENTION

This invention discloses a novel method and apparatus for Matrix Computing. It introduces a new machine and instruction set architecture with a capacity for a large number of instructions that allows for computing with arrays and matrices. It discloses a novel embedded storage space inside a processing unit for holding the matrices and arrays for computing along with new matrix pointer registers to access these. These matrices and arrays can be accessed either by columns or by rows or both concurrently, for computing. A set of machine instructions and methods to load, store and compute with these matrices are also disclosed; methods and apparatus to secure, share, lock and unlock this embedded space for matrices under the control of an Operating System or a Virtual Machine Monitor are also disclosed. A novel method and apparatus to handle immediate operands used by instructions using Immediate mode addressing are also disclosed.

### BRIEF DESCRIPTION OF THE DRAWINGS

FIG. 1 is block diagram of a generic SIMD computation unit with a Vector register file as seen in prior art.

FIG. 2(a) shows the structure of instructions used in this machine architecture.

FIG. 2(b) shows the various instruction types used in this machine architecture.

FIG. 2(c) is a Flowchart for instruction length decoding.

FIG. 3(a) has a block diagram of a microprocessor embodiment with a Matrix Processing Unit composed of a Matrix Space with its ports and internal bus interfaces, a Matrix Pointer register file and arithmetic, logic and other execution units.

FIG. 3(b) is a detailed functional diagram of an embodiment of the invention showing the Matrix Space to hold matrices and arrays in a processing unit with ports and interface buses and the associated Matrix Pointer register file as disclosed.

FIG. 3(c) is an embodiment of the fields of a Matrix Pointer Register.

FIG. 4(a) is an embodiment of matrix instruction types used in computation.

FIG. 4(b) is an embodiment of a program sequence to compute with matrices.

FIG. 5(a) is a Flowchart disclosing an embodiment of a method of executing a machine instruction to perform a matrix arithmetic or array computation.

FIG. 5(b) is a Flowchart disclosing an embodiment of a method to Load a matrix or array from System Memory.

FIG. 5(c) is a Flowchart disclosing an embodiment of a method to Store a matrix or array into System Memory.

FIG. 6(a) is an embodiment of the Move-Immediate (MVI) instruction as in prior art;

FIG. 6(b) is an embodiment of an Add-immediate to Register (ADDI r_dest, r_src, imm16) instruction as seen in prior art;

FIG. 6(c) is an embodiment of an Immediate Operand register;

FIG. 6(d) is an embodiment of an assembly instruction sequence showing the Payload instructions used along with some immediate operand instructions;

FIG. 6(e) is a Flowchart of a method for computing the value of the immediate operand from a Payload instruction and using it with the coupled immediate operand instruction.

FIG. 7 shows an embodiment of a Matrix Space divided into 4 Matrix Regions each secured by a triad of keys

### BACKGROUND OF THE INVENTION AND DESCRIPTION OF PRIOR ART

The prior art Reduced Instruction Set (RISC) Architectures have used fixed word length sizes for computing. With fixed word length the number of instructions in RISC architectures cannot grow over generations beyond a limit. They have been upgraded for SIMD computing with vector registers and vector computing units. In contrast, the so called Complex Instruction Set (CISC) Architectures for computing have utilized variable word length instructions. Their complexity often derives from the difficulty in determining the word length and the use of memory operands in a large number of instructions including those that use the Arithmetic Logic Units (ALU)s and other computational units. Many of these have been upgraded to perform SIMD computation with vector registers. Each has several disadvantages associated with their complexity or extensibility.

The present disclosure introduces a new invention for Matrix or Array Computing with an apparatus and a large set of novel instructions that strive to alleviate the disadvantages of these prior art computing architectures. It also introduces a novel Payload Instructions to handle immediate operands such that more bits are available for decoding of instructions and hence grow the instruction set size significantly with new instructions over many generations.

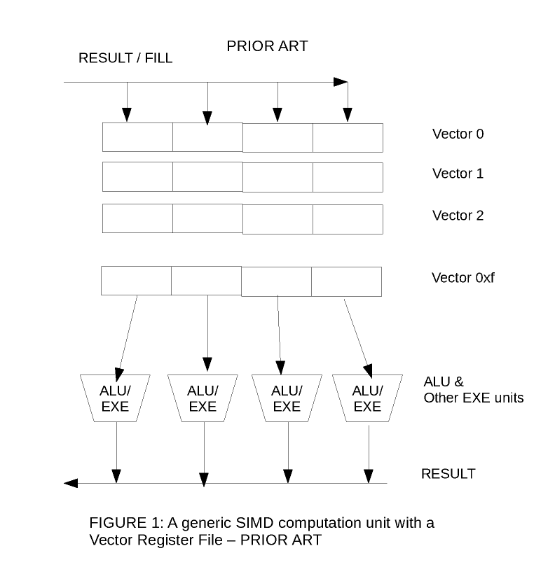

A generic design of a SIMD computation unit with a Vector Register File as seen in prior art is shown in FIG. 1.

### DETAILED DESCRIPTION OF THE INVENTION

The invention disclosed in here is a novel machine architecture which uses an instruction set with highly structured multiple word length instructions, the lengths of which are in exact multiples of 16-bits. This ISA is designed to accommodate a whole class of novel machine instructions for Matrix and Array Processing. It is designed such that a stand-alone machine can be built using only the 16-bit length instructions; further, a machine using 16-bit and a subset of 32-bit instructions can also be built. Alternately, the entire set of 16-, 32- and 48-bit length instructions can be used to build a processing unit. It can be extended to use 64-bit length instructions also. The 16-bit length and 32-bit length instructions are usable in all machines with 16-bit or wider address buses and 16-bit or wider operand registers.

Throughout this disclosure a 16-bit instruction refers to a machine instruction with number of bits in it equal to 16. It does not imply the size of the addressable memory space it can cover nor the default sizes of the operands or data width used in most instructions. While it is understood that a large number of elements of this invention are related to and depend upon prior art, this in no way diminishes the novel elements in the design of this invention which are exclusive to it.

This machine architecture utilizes a novel design to handle immediate operands used in its immediate addressing mode instructions whose details are disclosed later in this disclosure. This mechanism allows a large number of instructions to be used in the design.

### Structure of the Instructions

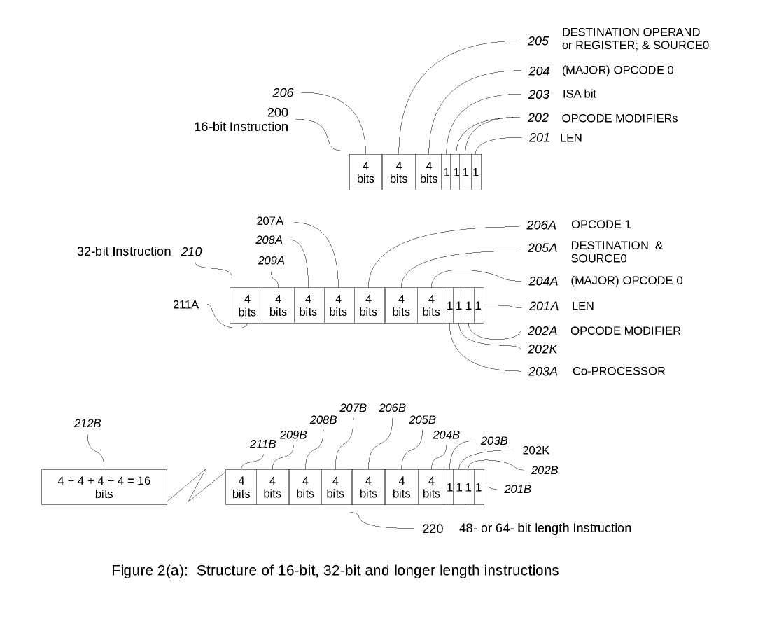

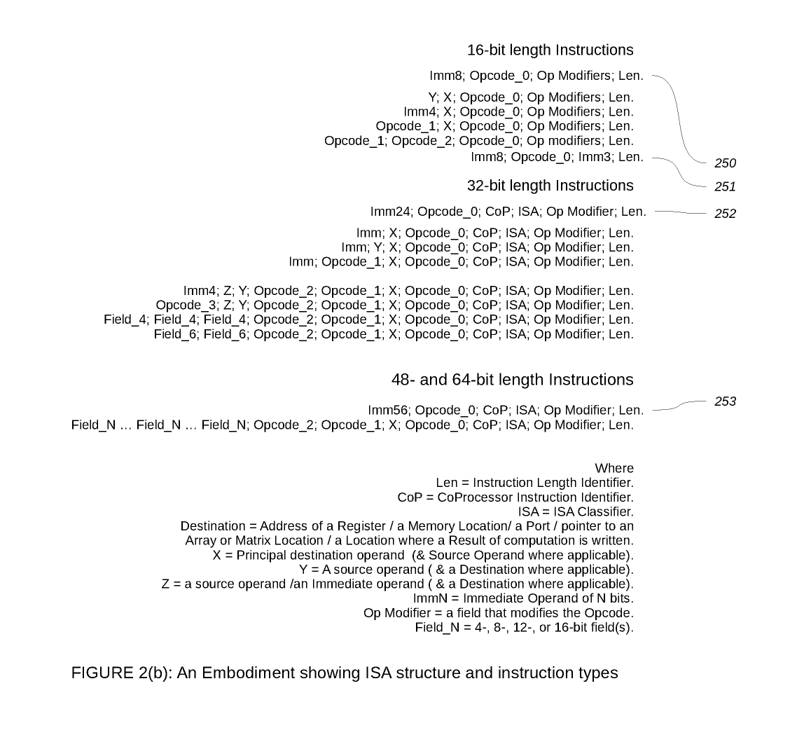

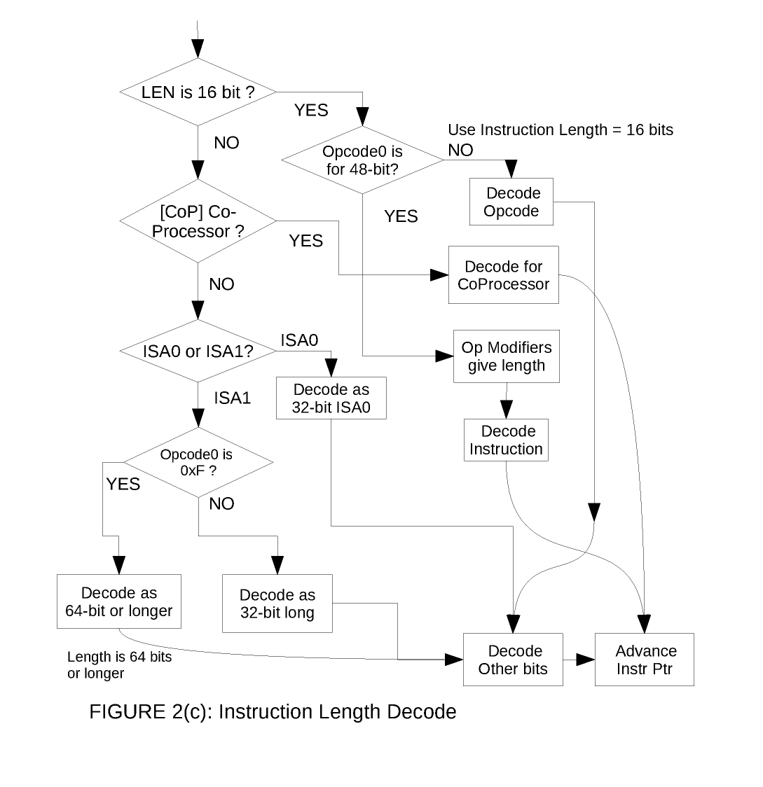

The instructions for this machine are highly structured (embodiments of which are shown in FIG. 2(a)) and are divided into 16-bit length, 32-bit length, 48-bit and 64-bit lengths. Two fields specific to this machine are:

1. A 1-bit field [201, 201A, 201B] called the LEN bit, to determine instruction length. It differentiates 16-bit instructions from instructions of longer length and significantly simplifies instruction length determination by the instruction decoder;

2. A 1-bit field [202K] called ISA bit used to partition the instruction set into 2 sub-sets for the purpose of easily creating less comprehensive embodiments of the machine for business reasons;

3. A 1- or 2-bit field [202, 202A or 202B] called OPM or OP Modifier used along with the ISA bit to modify the operation of the primary Opcode;

4. A 1-bit field [203A, 202B] in [210] and [220] called the Co-Processor or CoP bit that identifies instructions to be used by any built-in special function application specific co-processor. In a machine using only 16-bit instructions, the LEN bit is not expressly needed and it assumes the function of the CoP or Co-processor bit instead.

FIG. 2(b) shows more details of the instruction types used in this invention. Instructions [250], [251], [252] & [253] show 4 embodiments of the Payload Immediate instruction. The Payload Immediate instruction is a novel invention that is used to supply immediate values to all instructions that use immediate operands. This is disclosed further in a latter section in this disclosure.

The flowchart in FIG. 2(b) outlines how the LEN bit and the ISA bit are used to determine the length of an instruction. If the LEN bit [201, 201A, 201B] indicates a 16-bit instruction then the instruction is dispatched to the 16-bit decoder. The 48-bit instructions are concatenations of a 16-bit instruction (where LEN bit [201] indicates 16-bit length) and a 32-bit instruction that follows (where the LEN bit [201A] indicates a 32-bit length). If the 16-bit decoder determines the Opcode0 [204] to be a Payload Immediate or a 48-bit instruction Opcode (as in the flowchart of 2(b)) then the following 32-bit instruction is concatenated to this 16-bit instruction to decode a 48-bit instruction. Two 16-bit Payload instructions may also be concatenated with a third 16-bit instruction to create an instruction that is effectively 48-bits long. The 64-bit instructions may be formed with Payload Immediate instructions or by concatenated decoding of two 32-bit instructions where the first one indicates 64-bit length. It is also possible to concatenate a sequence of Payload Immediate instructions [250, 251, 252, 253] to create instructions that are effectively 64 bits and longer. However, the Payload Immediate instructions are complete in themselves and are decoded and executed by themselves but they may or may not be retired prior to the consumption of the immediate operand by the instruction that follows depending on the embodiment designed.

### Matrix and Array Processing

In prior art, Matrix computations are done by a Central Processing Unit using vector registers and SIMD instructions. An embodiment of prior art is shown in FIG. 1(a). All matrices are stored, loaded and processed as 1-dimensional vectors in prior art. Alternately, special purpose units called systolic arrays are used to process matrices. Systolic array is: “A grid like structure of special processing elements that processes data much like an n-dimensional pipeline. Unlike a pipeline, however, the input data as well as partial results flow through the array.” Systolic arrays use a matrix of computational units with local storage to hold the operands of computation.

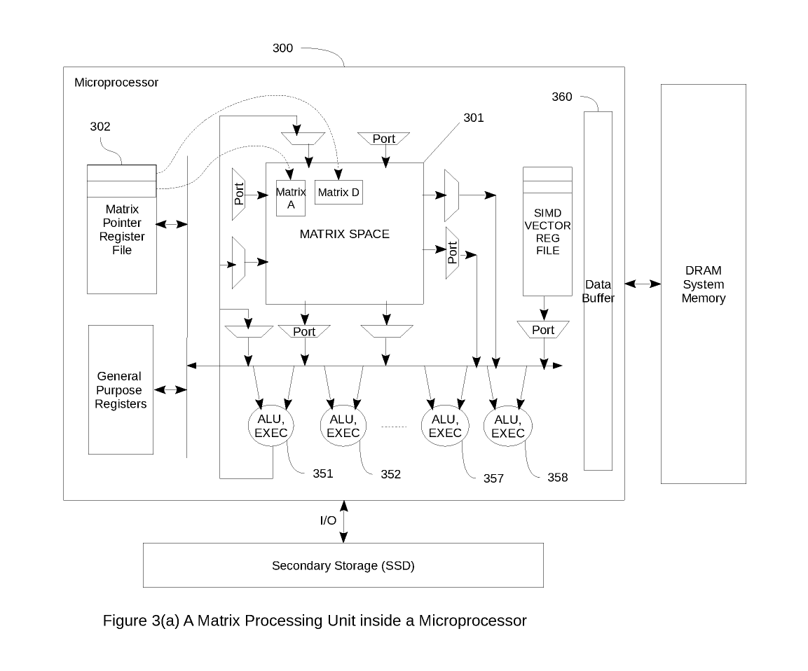

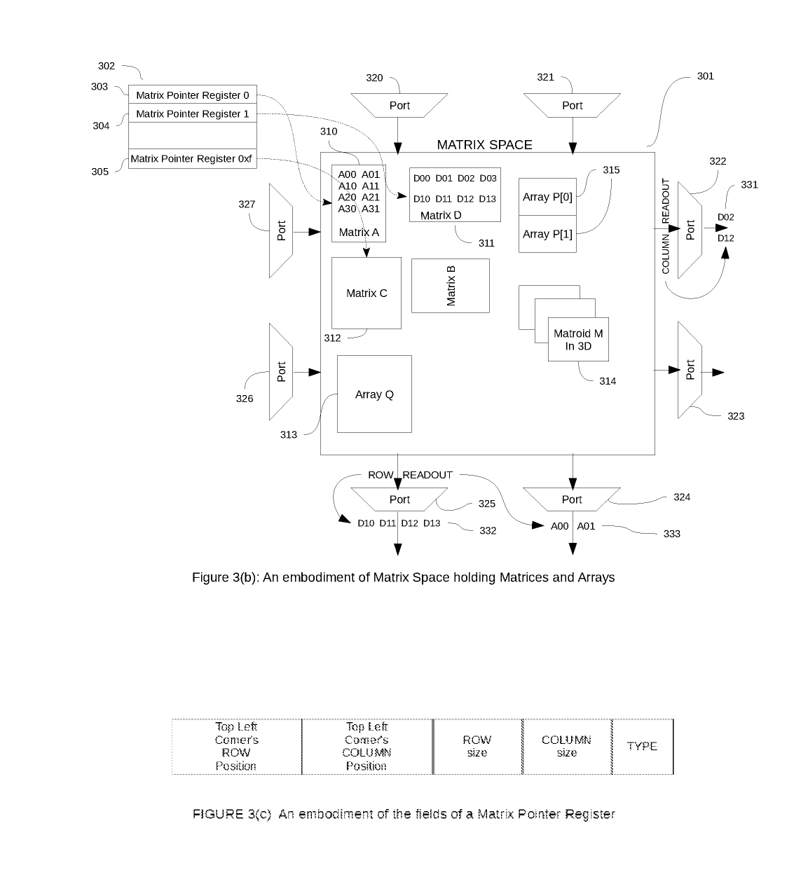

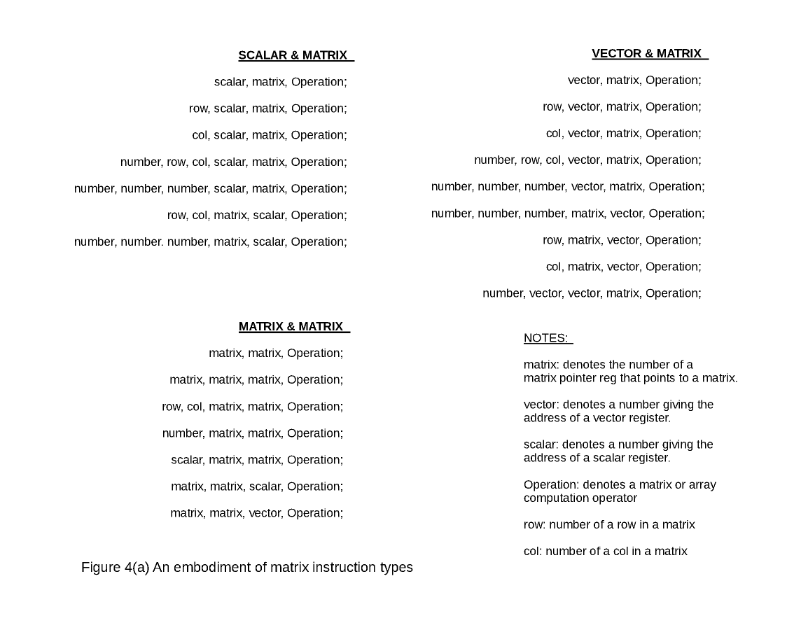

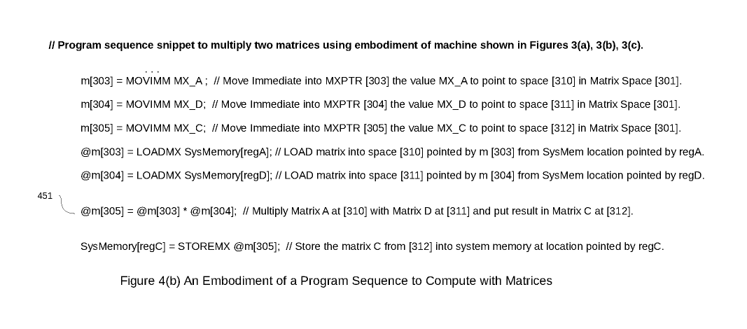

This invention uses a different mechanism inside a Matrix Processing unit. An embodiment of such a unit is shown in FIGS. 3(a) & 3(b). Inside a Microprocessor [300] an embedded Random Access Memory (RAM) based storage [301] called Matrix Space is used to hold a plurality of Matrices (Matrixes) [310, 311, 312, 313], Matroids [314] (arrays of higher than 2 dimensions used in mathematics, physics and engineering) or multi-dimensional (numerical and non-numerical) any generic Arrays [315] for computation inside a processing unit. The Matrix Space is a RAM that can be accessed by its Rows as well as by its Columns in two dimensions X and Y in a single semiconductor chip. In the future it is conceivable that this Matrix Space RAM may be accessed in 3 dimensions X, Y, Z, where the Matrix Space RAM is implemented over semiconductor chips that are stacked to create 3-Dimensional chips. It may also be possible in the future for other novel materials or technology to render possible a 3-Dimensional Matrix Space with Ports in all 3 dimensions providing access to Matroids and Arrays (held in 3-D) in 3-Dimensions.

### Matrix Instructions

A set of Matrix Pointer registers [302] (see FIG. 3(b)) along with a set of novel instructions called Matrix Instructions in the instruction set are used to access these matrix and array entities from the Matrix Space [301] to execute array or matrix operations for matrix arithmetic inside a processing unit [300] shown in the embodiment in FIGS. 3(a), 3(b), 3(c).

An embodiment of a set of matrix instruction types is shown in FIG. 4(a). For matrix and array processing a variety of instructions are needed which map arithmetic, logic, transport, string and other operations into these types.

The following is a small partial list of exemplary matrix operations that can be performed with this invention.
Loading a Matrix from System Memory into Matrix Space
Storing a Matrix to System Memory from Matrix Space
Accessing individual rows and columns of a matrix or array for reading or writing
Using rows or columns of the matrix for vector operations with vectors
Counting, re-ordering, sorting elements of rows or columns of a matrix or array
Moving or copying a Matrix inside a Matrix Space
Transposing a Matrix or array inside Matrix Space
Performing addition, subtraction, multiplication and other matrix arithmetic, logic, discrete math, string and flow control operations involving matrices, vectors, arrays, scalars or other multi-dimensional structures
Creation of sparse matrix or sparse array
Matrix arithmetic, logic, discrete math and flow control operations on sparse matrices and sparse arrays
Executing other elementary matrix, array or graph processing including search, sort, rearrange, filter, text and string processing, graph traversal, table pivoting and many others.
Adding or subtracting a Register to or from a Matrix Pointer Register
Adding or subtracting an Immediate value to or from a Matrix Pointer Register
Moving contents of a Matrix Pointer to another Matrix Pointer or to a general register
Loading and Storing a Matrix Pointer register
Other operations on contents of a Matrix Pointer register

### Accessing a Matrix in Matrix Space Using Matrix Pointer Registers

In the embodiment in FIGS. 3(a), 3(b), 3(c) a Matrix A is stored in a matrix allocation [310] inside the Matrix Space [301] inside a microprocessor [300], and is pointed to by the contents of a Matrix Pointer register [303].

An embodiment showing the contents of the Matrix Pointer register and associated Types is shown in FIG. 3(c). The Matrix Pointer register word [380] holds the row address [381] and column address [382] of the location of a specific element (typically a corner location) of a matrix allocation [310] it points to in the Matrix Space, along with the size (number of rows [383] and number of columns [384]) of the matrix, and its Type [385].

In the embodiment in FIGS. 3(a), 3(b), 3(c), Matrix Pointer register [303] pointing to a 4×2 Matrix A at [310] holds row and column addresses of element A00 in matrix A at [310]. The number of rows [383] would be 4 and number of columns [384] would be 2. The Type [385] identifies the type of the elements which constitute the matrix like Byte, Short integer, Integer Word, Long integer, Pointer (to a memory location), Ordered Pair of Integers, Ordered Quad of Shorts, Triad of values, Half precision float, Single precision float, Double Precision Float, Extended Precision Float, Ordered Pair of Singles, Nibbles, bits, di-bits, and so on.

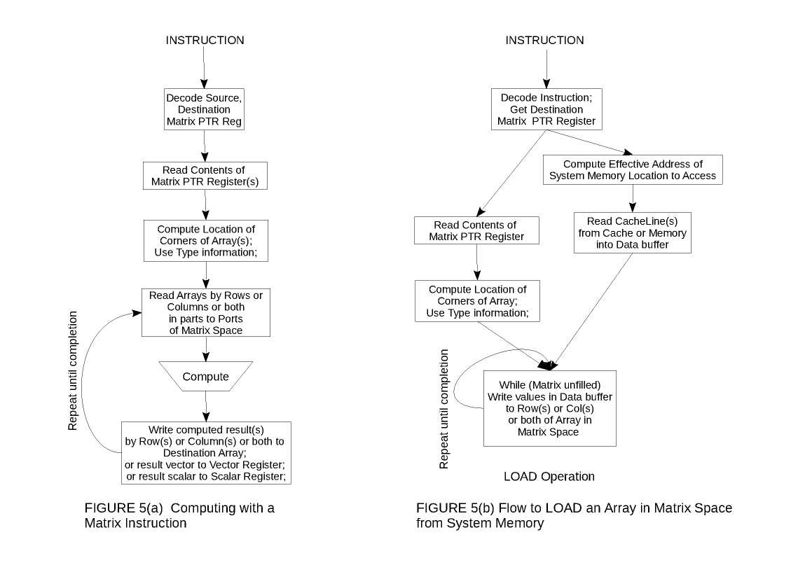

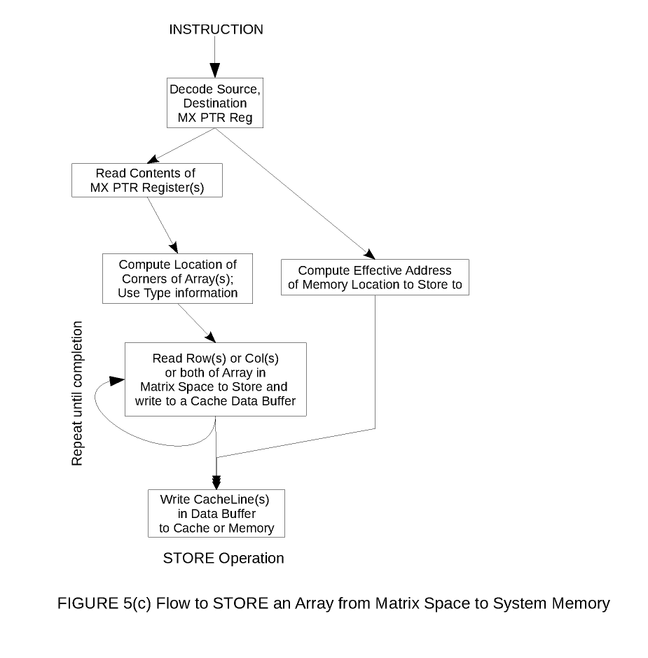

In the embodiment in FIGS. 3(a), 3(b), 3(c), matrix A at [310] in the Matrix Space [301] is accessed for an operation as follows: In the embodiment of a program in FIG. 4(b), a matrix instruction [451] with the register number of Matrix Pointer register [303] pointing to matrix A at [310], and the register number of [304] pointing to matrix D at [311] as source operands executes, Also provided in instruction [451] is the register number of Matrix Pointer register [305] pointing to matrix C at [312] as the destination operand. The contents of matrix pointers [303], [304] & [305] are first read. The addresses of two diagonally opposite corners (like the top-left and bottom-right corners) of the corresponding matrices (matrixes) inside the Matrix Space are computed using the fields [381, 382, 383 and 384] and interpreted along with the Type [385] of the elements of A and D. Based on the operation type, the rows or columns (or both) of matrix A and matrix D are read out one or more at a time and used in computing the result. In this embodiment row [333] of matrix A with contents [A00 A01] are read out on port [324]. Also read out are column [331] with contents [D02 D12]^{T} on port [322] and row [332] with contents [D10 D11 D12 D13] of matrix D at [311] on port [325]. These are then used to compute the result using execution units [351 through 358] in FIG. 3(a). The result is deposited into Matrix C at [312] in the Matrix Space [301] at the location specified by contents of [305] via the port [320]. The Type [385] of C is updated correctly based on the result produced by the instruction. If a computation requires additional matrices, vectors or scalar values to be used then these are also read using appropriate methods and utilized in the computation or in the generation or storage of a result. The result(s) may be written by row or column (or both) into a matrix held inside the Matrix Space, or into a vector register, or a regular scalar register as specified by an instruction. The process of accessing or computing is similar for a non-numeric array of elements held in the Matrix Space. A flowchart for this method is shown in FIG. 5(a).

Prior to accessing the contents of the Matrix Space a security and correctness check may also be conducted in Hardware. In the event of a protection error, access error or an execution error, an appropriate abort, or trap, or fault or exception may be taken.

Loading a Matrix from System Memory

In order to use an array or a matrix it is necessary to load it from system memory into the Matrix Space. Flowchart in FIG. 5(b) outlines the method for loading a matrix into the Matrix Space. Following the flowchart in the context of the embodiment in FIGS. 3(a), 3(b), 3(c) and using an example of an embodiment of a LOAD Matrix instruction the method to load a matrix A into Matrix Space is as follows.

A LOAD Matrix instruction is read and decoded within the microprocessor [300] and the number of a Matrix Pointer register [303] is decoded. Also decoded is a register with a pointer to a system memory location. The effective address of a System Memory (often called DRAM in common parlance) location is computed and a typical cache line or a block of data containing the values of the elements of Matrix A originating at that location are read into a data buffer [360] inside microprocessor [300]. Referring to the embodiment in FIGS. 3(a), 3(b), 3(c), the contents of Matrix Pointer register [303] are read and the location and size of Matrix A at [310] in terms of the number of rows and columns and number of elements are determined using the fields [381], [382], [383] and [384] as shown in FIG. 3(c). It is presumed that the contents of register [303] including its Type information are set up appropriately for Matrix A prior to the LOAD instruction by the program sequence. The contents of the data buffer [360] are read and transferred in plurality of chunks representing rows or columns or both of Matrix A into their location [310] in Matrix Space [301] via a plurality of ports [320], [321], [326], [327] shown in FIG. 3(b). The transfer can occur either by writing the rows or columns or both, into [301]. The LOAD instruction is then retired, thereby completing the process.

It is conceivable that in another embodiment of this invention, a matrix or array in Matrix Space may be accessed or loaded by using the fields in a longer machine instruction that encode its location, size and type, thereby not using a matrix pointer register.

Storing a Matrix from System Memory

It is also necessary to store the result matrix (or matrices) into system memory. Following the method in the Flowchart shown in FIG. 5(c) to store a Matrix A labeled [310] in Matrix Store [301] in the embodiment shown in FIGS. 3(a), 3(b) & 3(c), a program sets up the position, size and type attributes [380] into Matrix Pointer Register [303] prior to the use of the STORE instruction. The STORE instruction is decoded inside microprocessor [300] and the number of a register holding a pointer ptr_A into system memory is determined along with the number of the Matrix Pointer register [303]. The pointer ptr_A is used to compute an effective address pointing to a location of a buffer for matrix A in system memory or its image in a cache. Also read are the contents of [303] giving the extent or size of Matrix A at [310] along with the position of [310] as discussed earlier in this disclosure. The contents of Matrix A are read from its location [310] inside Matrix Space [301] by row or by column or both and transferred to Data Buffer [360]. The contents of the data buffer [360] are transferred to a cache in the microprocessor or to system memory and the instruction is retired to complete the process of storing matrix A.

### Space Allocation for a Matrix Used in a Process

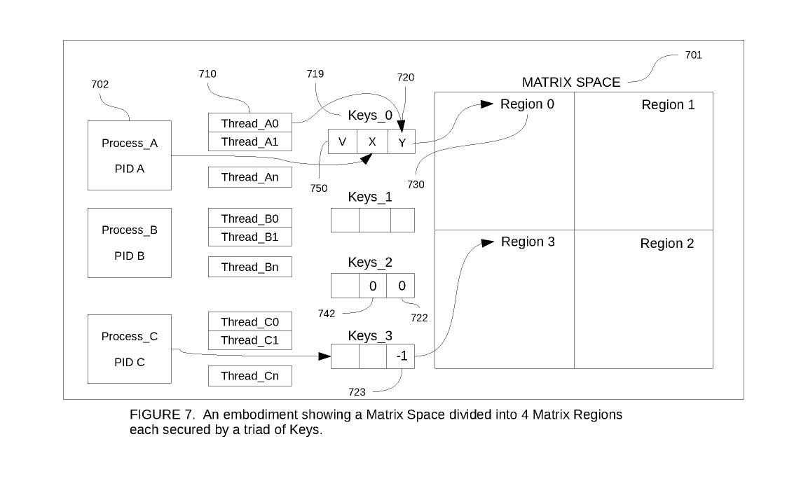

A Matrix Space in a microprocessor may be divided into 2, 4, 8 or larger number of matrix regions depending on its size to control ownership rights. In the embodiment of FIG. 7, the Matrix Space [701] is divided into 4 matrix regions, each of which can be independently Secured and Shared by assigning them properties using a plurality of privileged instructions by an operating system or a virtual machine (VM) monitor (also referred to as a hypervisor) running on the microprocessor.

The properties of the region are assigned by the OS or VM hypervisor based on policies that may be configured a priori and as requested by an application process. A process thread may make further OS calls to request a set of attribute values for sharing and security settings to govern the allocated region.

At the time of region allocation the OS may clear the information content or values held in that region of the Matrix Space. An Allocation policy setting may be used to forbid any instruction from causing the contents of a region to be transferred to another region or be used as a source operand in a computation whose results go to another region.

In the embodiment in FIG. 7, the region 0 at [730] is secured by a thread Thread_A0 listed in a thread register [712] of a process [702] with process identifier numbered or named Process_A by an Operating System call. This call uses a privileged instruction called Matrix Allocate to assign a free region to a process for matrix computing among those available in a list maintained by the OS or a VM hypervisor.

### Locking and Unlocking Allocated Regions on a Context Switch or an Interrupt

In a divided Matrix Space each matrix region is controlled by three keys—
(1) one key called the Group Key is associated with either an OS (in a multi-OS environment)
   or a Process Group Identifier (as in, an identifier of a collection of PIDs (Process Identifiers) associated with a plurality of processes collected into a group that are running on a system under an OS);
(2) a second key called the Process Key is associated with an individual process via its process identifier (PID);
(3) and, a third key called the Thread Key is associated with a group of threads inside a process.

Each matrix region may have an associated Keys register with 3 fields each holding one of the above keys. One fixed value of a key may be used to block all threads of a process from accessing an associated region. Another fixed value of a key may be reserved for enabling all threads of a process to access that region of Matrix Space.

In one embodiment, a 0 value in the Thread Key field of a region would block all threads in a process from accessing the region while an all 1s value (equal to −1) in that field would enable all threads of that process to access the region. Similarly, a 0 value in the Process Key field of a matrix region's Key register would prevent every process in the associated process group from accessing the region while an all 1s value would enable all processes in the associated process group to access that region of Matrix Space. Key values other than 0 or all 1s are leased to individual processes by an OS or VM hypervisor to allow them to access specific regions of Matrix Space leased to them by an OS or hypervisor while blocking all other processes. Such a capability would be required when an interrupt occurs and the OS is required to run some other process or thread that must not access a region. This allows the OS to quickly swap out a process or thread while locking that matrix region to all others. Upon resumption of the process leasing the region, the HW unlocks the region allowing access to the thread(s) holding the key once again.

In the embodiment shown in FIG. 7, matrix region 0 at [730] is controlled by Key Register [719] named Keys_0 with its Thread Key field [720] holding a unique and non-zero random value Y assigned by OS exclusively and secretly to Thread [710] named Thread_AO. Here, Y which is not equal to all 1s, authenticates and enables only Thread_AO of the process named Process_A to access that region of Matrix Space.

The Thread Key field [723] controlled by Process_C has an all 1s value denoted by a −1 in the keys register Keys_3 which allows all threads of Process_C to access Region 3. Also, both the Process Key Field [742] and Thread Key Field [722] hold a 0 value each. This locks up region 2 to all processes and threads. Only the OS or VM hypervisor may unlock the region by resetting the keys. The Key Field [750] is used to put a region under the control of an OS by a VM hypervisor or to restrict access to a smaller pool of processes by an OS.

In any embodiment it is not necessary to implement all or any of the keys or key fields. Implementing a key for allowing and blocking processes is deemed beneficial for performance and ease of use. The same concept of keys can be extended further in other embodiments to control locking and sharing properties of individual regions or group of regions themselves.

Without loss of generality it is understood that Regions may also be controlled recursively using multiple keys, where sub-regions of regions may be more finely or coarsely controlled. While dynamically shaping and reshaping the Matrix Space into arbitrarily sized and arbitrarily shaped regions in an embodiment is possible, its utility is not much more than doing it quasi-statically at the beginning by an OS or VM hypervisor.

Matrix Lock and Matrix Unlock Instructions with operands to copy to or write to key registers are provided for locking and unlocking specific matrix regions used by a process or its thread(s) where it holds its matrices or vectors for its computations. An encryption mechanism may be used with the keys for authentication in order to strengthen the lock.

Method and Apparatus for Handling Immediate Operands in Machine Instructions

Prior Art has a variety of machine instructions for moving, adding, subtracting and other operations that use an immediate operand embedded in the instruction.

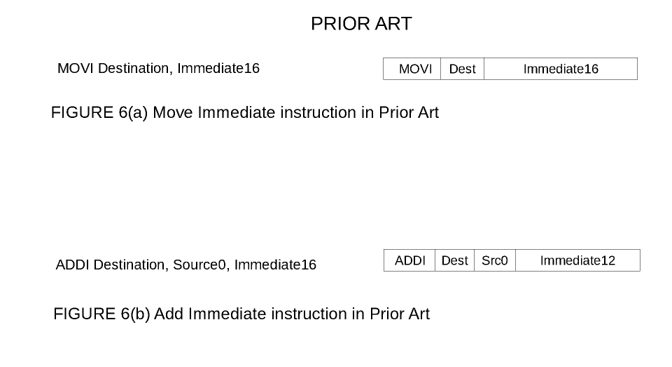

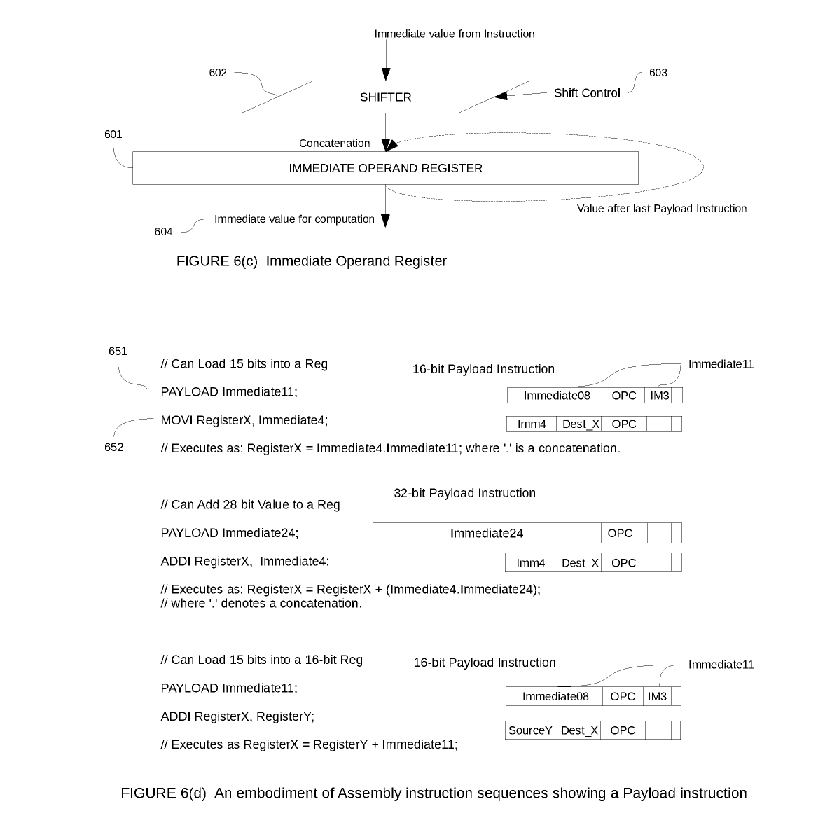

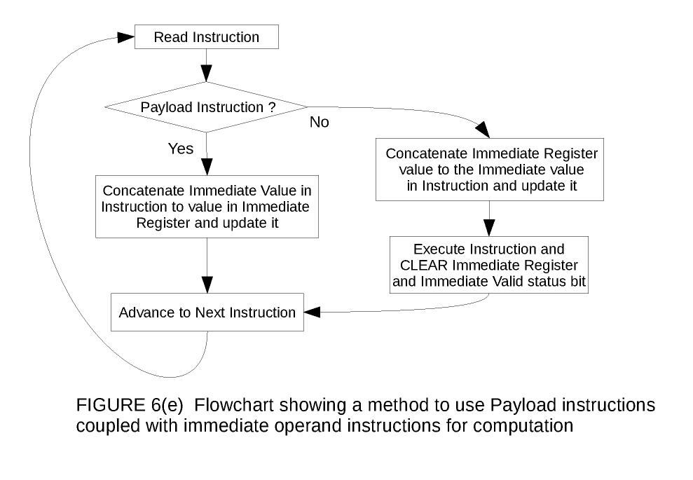

FIGS. 6(a), (b) show two embodiments of generic assembly level instructions consuming immediate operands as seen in prior art, hereinafter referred to as Immediate Instructions. For e.g. FIG. 6(a) shows an embodiment of the Move-Immediate (MVI) instruction and FIG. 6(b) shows an embodiment of an Add-immediate to Register (ADDI r_dest, r_src, imm16) instruction as seen in prior art. In the case of MVI instruction, as in a CISC ISA, the instruction length varies based on the length of the Immediate Operand. The varying instruction length often requires a complex instruction length decoder. In case of the ADDI instruction as used in this RISC machine the length of the immediate operand is fixed to 16-bits and a number with a larger number of bits cannot be used.

This invention solves the above problem of using longer immediate operands beyond what can be accommodated in a single machine instruction for a RISC like architecture in a novel way. This is done by introducing a Payload instruction that simply moves an Immediate value into a temporary Immediate-Operand Register as shown in FIG. 6(c), either prior to or after the desired operational Immediate Instruction that consumes it in an assembly or machine language program. An embodiment of the assembly instruction sequence using Payload instructions in conjunction with ADDI instructions is shown in FIG. 6(d).

A 16-bit instruction with an immediate operand can have its immediate operand length extended from a mere 4 bits in an embodiment to a longer 15 bits or even to 28 bits, if necessary, while incurring the cost of introducing a payload instruction.

The invention also allows a plurality of payload instructions to be cascaded in a sequence to create longer immediate operands limited only by the design of the actual embodiment of the physical machine. The downside of this method is the overhead incurred due to the bits that are allocated to the Payload instruction's Opcode but it helps making the instruction decoder much simpler.

It may be noted that the method disclosed in the invention is different from the prior art of loading a register with an operand using a move immediate instruction and then performing a second operation using that register operand. This is because the Move-Immediate or Load-Immediate operation itself can have its immediate operand extended using a Payload instruction and it also does not consume an addressed register out of a register file. Also the immediate operand length is enhanced with each sequential Payload instruction before the immediate operand is consumed by an operation; hence the novelty.

Following the Flowchart in FIG. 6(e) as applied to the embodiment in FIG. 6(c) executing the program sequence in FIG. 6(d), a PAYLOAD Immediate11 instruction [651] is decoded and the Immediate11 operand is moved into the Immediate Operand Register [601] via shifter [602] into bits [10 . . . 0]. The shift amount applied is 0 since this is the first Payload instruction. Next, the shift control [603] for shifter [602] is set to 11 and the operand Immediate4 operand obtained from decoding the succeeding MOVI instruction [652] is presented as data input to shifter [602] and the shifted output [604] is loaded into bits [15 . . . 11] of the Immediate Operand register, completing the concatenation. The MOVI instruction execution completes by moving the value in the Immediate Operand register into RegisterX, then CLEARing the Immediate Operand register to 0 and retiring the instruction.

1. A novel machine architecture and instruction set with highly structured multi length instructions in exact multiples of 16-bits (i.e. 16 bits, 32 bits, 48 bits, 64 bits, etc.) designed to include a whole class of novel machine instructions for Matrix Processing;
It is also designed such that a stand alone machine can be built using the subset of only the 16-bit instructions or a combination of 16-bit and 32-bit machine instructions put together;
a 1-bit field called the LEN to determine instruction length that differentiates 16-bit instructions from instructions of longer length;
a 1-bit field called ISA used to partition the instruction set into 2 sub-sets for creating less comprehensive embodiments of the machine for business purposes;
a 1- or 2-bit field called OP Modifier used along with the ISA bit to modify the operation of the primary Opcode;
a 1-bit field called the Co-Processor that identifies instructions to be used by any built-in special function application specific co-processor.

2. An embedded storage called Matrix Space to hold matrices (matrixes) or single or multi-dimensional arrays and vectors of numeric or non-numeric or packed groups of values for computation whose elements can be accessed by rows or by columns or both;
along with Matrix Space, a set of machine instructions (and their assembly language equivalent) to access, load, store, restore, set, transport, perform operations including arithmetic and non-arithmetic operations to execute steps of algorithms and or manipulations of the aforementioned arrays or matrices or any of the contents within the Matrix Space along with contents of other registers or storage outside it;
hardware, methods and instructions to control the state of the Martrix Space (including operations to reset, power on, power down, clock on, clock off or anything else that may change its state).

3. A set of Matrix Pointer registers that hold location and size information of matrices and arrays stored in the Matrix Space of claim 2 and are used to access a plurality of elements of these matrices and arrays by rows, by columns, or both or in other possible ways;
along with these matrix pointer registers, machine instructions (and their assembly language equivalent) in the instruction set to access, load, store, restore, set and compute with the contents of these registers and the contents of the vectors, matrices or arrays inside or associated with the Matrix Space, including those held in system memory or other registers outside these.

4. A matrix for computation is stored in the Matrix Space and is pointed to by the contents of a Matrix Pointer register. A Matrix Pointer word holds the row and column addresses of the location of a pre-designated element-position in a matrix, typically a corner location (but not limited to it) along with the size (in number of rows and columns) of the matrix; a Type designation which identifies the type of the elements which constitute the matrix like Byte, Short integer, Integer word, Long integer, Pointer (to a memory location), Ordered Pair of Integers, Ordered Quad of Shorts, Triad of values, Half precision float, Single precision float, Double Precision Float, Extended Precision Float, Ordered Pair of Singles, Nibbles, and others;
a plurality of methods and accompanying logic to access one or more matrix (or matrices) or array(s) in the Matrix Space for an operation, wherein the contents of one or more matrix pointer registers are read; the addresses of two diagonally opposite corners (like the top-left and bottom-right corners) of said matrix (matrices) inside the Matrix Space are computed and the number of rows and columns of the matrix or array are interpreted along with the Types of the elements of those matrix (matrices) or arrays;
based on the operation type, the contents in the rows or columns (or both) of one or more matrix (matrices) or array(s) are read many at a time and used in computing a result. If the result computation requires vectors or scalar values to be used these are also read using appropriate methods from their locations of storage;
a plurality of methods to store the results of computation by row or column (or both) into a matrix held inside the Matrix Space via its ports or into vectors or a regular scalar registers as the case may need;
a plurality of methods and accompanying logic to load one or more matrix (matrices) or arrays from system memory or a processor cache into the Matrix Space using a Matrix Load instruction;
a plurality of methods and accompanying logic to store one or more matrix (matrices) or arrays into system memory or a processor cache from the Matrix Space using a Matrix Store instruction.

5. A plurality of instruction structures or types and a plurality of instructions for computing with matrices and arrays of numeric and non-numeric elements and using these along with vectors and scalars in registers and numbers and immediate values of any type.

6. A spatial division of aforementioned Matrix Space into a plurality of matrix regions and a plurality of instructions and logic to control the security and sharing attributes of these regions. Attributes which secure the region to be accessible by specific threads of specific processes;
a set of Keys registers to hold a plurality of keys to block or enable access to each region by specific threads of specified processes that lease these secret or encrypted keys from the OS or a virtual machine hypervisor;
a set of canonical key values like 0 and −1 (all 1s) to denote complete blocking or full access to all threads or all accesses that may be used as keys;
a method and a key field to allow an OS to control a region of matrix space as stipulated by a VM hypervisor;
methods and logic to lock or unlock access to each matrix region in the aforementioned Matrix Space by a thread of a process making a request to an OS using a privileged instruction under OS control.

7. An Immediate operand register to be used in conjunction with certain Immediate instructions; a Payload instruction comprising of an opcode and an Immediate value operand to be stored by a processor into an Immediate-Operand register inside;
a method and accompanying logic to decode the Payload instruction in a program sequence either prior to or after the decoding of another instruction with or without an immediate operand to be executed;
a method and logic including a shifter and a register that concatenate a value in an Immediate Operand register to an immediate operand of the then current incoming decoded instruction to create a longer Immediate operand;
to use the above resultant Immediate operand in the execution of an instruction other than a Payload instruction as one of the operands.
